(19) United States
(12) Patent Application Publication
(10) Pub. No.: US 2006/0002261 A1
(43) Pub. Date: Jan. 5, 2006

(54) Data reproduction apparatus having resume reproduction function, and program product for implementing resume reproduction function

(75) Inventor: Yoshikazu Fujita, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/172,220

(22) Filed: Jun. 29, 2005

(30) Foreign Application Priority Data
Jul. 5, 2004 (JP) 2004-198267

(51) Int. Cl. G11B 5/09

(52) U.S. Cl. 369/47.1; 369/53.1

(57) ABSTRACT

When a reproduction operation of data recorded on a recording medium is stopped, a stop position of the reproduction operation on the recording medium is obtained and stored in a position storage unit. Thereafter, when an input instructing resume reproduction is received, a time period elapsed from the time of stop of the reproduction is calculated. A resume position of the reproduction operation is determined with reference to the stop position stored in the position storage unit, based on the calculated time period.

### BACKGROUND OF THE INVENTION

1. Field of the Invention

The present invention relates to a data reproduction apparatus and a program product, and more particularly to a data reproduction apparatus having a resume reproduction function and a program product for implementing the resume reproduction function.

2. Description of the Background Art

A reproduction apparatus having a resume reproduction function has conventionally been provided, wherein stop position information at the time of interruption of reproduction is stored and data is read from the stop position upon restart of the reproduction. Various techniques utilizing the resume reproduction function have been disclosed.

For example, Japanese Patent Laying-Open No. 11-273227 discloses a DVD video reproduction system that performs digest reproduction for each chapter at the time of restart of reproduction up to the reproduction-intermitted position. Japanese Patent Laying-Open No. 2002-025235 discloses a resume reproduction method wherein the section between the reproduction start position and the reproduction stop position is divided and corresponding addresses are obtained, and at the time of restart of the reproduction, digest reproduction is performed based on the relevant addresses. Further, Japanese Patent Laying-Open No. 2002-281447 discloses an information reproduction apparatus wherein reproduction is restarted from the beginning of the scene to which the reproduction stop position belongs.

With the above-described techniques, reproduction is restarted at a position going back in time from the reproduction-intermitted position, which can refresh the viewer's memory of the content reproduced last time.

In the conventional reproduction apparatuses as described above, however, resume reproduction is carried out under a fixed condition, irrespective of time elapsed until restart of the reproduction.

### SUMMARY OF THE INVENTION

The present invention has been made to solve the above-described problem, and an object of the present invention is to provide a data reproduction apparatus and a program product enabling resume reproduction based on time elapsed until restart of the reproduction.

A data reproduction apparatus according to an aspect of the present invention includes: a reproduction unit for performing a reproduction operation of data recorded on a recording medium; a position obtaining unit for obtaining a stop position of the reproduction operation on the recording medium when the reproduction operation by the reproduction unit is stopped; a position storage unit for storing the stop position obtained by the position obtaining unit; a calculation unit for calculating a first time period elapsed from the time of stop of the reproduction operation when an input designating resume reproduction for the reproduction operation by the reproduction unit is received; and a resume position determining unit for determining a resume position of the reproduction operation with reference to the stop position stored in the position storage unit, based on the first time period calculated by the calculation unit. In this apparatus, the resume position determining unit determines a position going back by a second time period from the stop position stored in the position storage unit as the resume position, by selecting one of predetermined time periods as the second time period based on the first time period.

A data reproduction apparatus according to another aspect of the present invention includes: a reproduction unit for performing a reproduction operation of data recorded on a recording medium; a position obtaining unit for obtaining a stop position of the reproduction operation on the recording medium when the reproduction operation by the reproduction unit is stopped; a position storage unit for storing the stop position obtained by the position obtaining unit; a calculation unit for calculating a first time period elapsed from the time of stop of the reproduction operation when an input designating resume reproduction for the reproduction operation by the reproduction unit is received; and a resume position determining unit for determining a resume position of the reproduction operation with reference to the stop position stored in the position storage unit, based on the first time period calculated by the calculation unit.

Preferably, the resume position determining unit determines a position going back by a second time period from the stop position stored in the position storage unit as the resume position, by selecting one of predetermined time periods as the second time period based on the first time period.

Preferably, the data reproduction apparatus further includes a modification unit for modifying the predetermined time periods based on an instruction from a user.

Preferably, the data reproduction apparatus further includes a time obtaining unit for obtaining a stop time at which the reproduction operation by the reproduction unit was stopped. In this apparatus, the position storage unit stores the stop time obtained by the time obtaining unit and the stop position in association with each other.

Preferably, the data reproduction apparatus further includes a restart unit for restarting the reproduction of the data recorded on the recording medium from the resume position determined by the resume position determining unit.

Preferably, the position storage unit is included in the recording medium.

Preferably, the position storage unit is capable of holding information in a non-volatile manner.

Preferably, the recording medium is provided in advance in the data reproduction apparatus.

Alternatively, the recording medium may be removable.

Preferably, the position storage unit is capable of holding information in a non-volatile manner, and the position storage unit stores the stop position in association with identification information of the recording medium.

Preferably, the position storage unit stores the stop position and a stop time at which the reproduction operation by the reproduction unit was stopped, in association with each other.

Preferably, the position obtaining unit obtains the stop position based on a time period elapsed from the time when the reproduction operation of the data recorded on the recording medium was started to the time when the reproduction was stopped.

A program product according to a further aspect of the present invention records a program for causing a computer to perform resume processing, and the program includes: the step of performing a reproduction operation of data recorded on a recording medium; the step of obtaining a stop position of the reproduction operation on the recording medium when the reproduction operation is stopped; the step of calculating a first time period elapsed from the time of stop of the reproduction when an input designating resume reproduction for the reproduction operation is received; and the step of determining a position going back by a second time period from the obtained stop position as a resume position of the reproduction operation, by selecting one of predetermined time periods as the second time period based on the calculated first time period.

Accordingly, a data reproduction apparatus and a program product that allow the resume reproduction to be carried out based on time elapsed until restart of reproduction are provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a hardware configuration of a DVD recorder according to an embodiment of the present invention and a modification thereof

FIG. 2 is a functional block diagram of a system control circuit in the embodiment of the present invention and the modification thereof

FIG. 3 is a flowchart illustrating resume processing when reproduction is stopped in the DVD recorder of the embodiment of the present invention.

FIG. 4 is a flowchart illustrating resume information holding processing in the embodiment of the present invention.

FIG. 5 is a flowchart illustrating resume reproduction processing when reproduction is restarted in the DVD recorder of the embodiment of the present invention.

FIG. 6 is a flowchart illustrating resume processing when reproduction is stopped in a DVD recorder according to the modification of the embodiment of the present invention.

FIG. 7 is a flowchart illustrating resume reproduction processing when reproduction is restarted in the DVD recorder of the modification of the embodiment of the present invention.

### DESCRIPTION OF THE PREFERRED EMBODIMENTS

Hereinafter, embodiments of the present invention will be described in detail with reference to the drawings. Throughout the drawings, the same or corresponding elements have the same reference characters allotted, and description thereof will not be repeated.

A data reproduction apparatus according to an embodiment of the present invention is now described. In the present embodiment, a DVD recorder as a type of the data reproduction apparatus is employed.

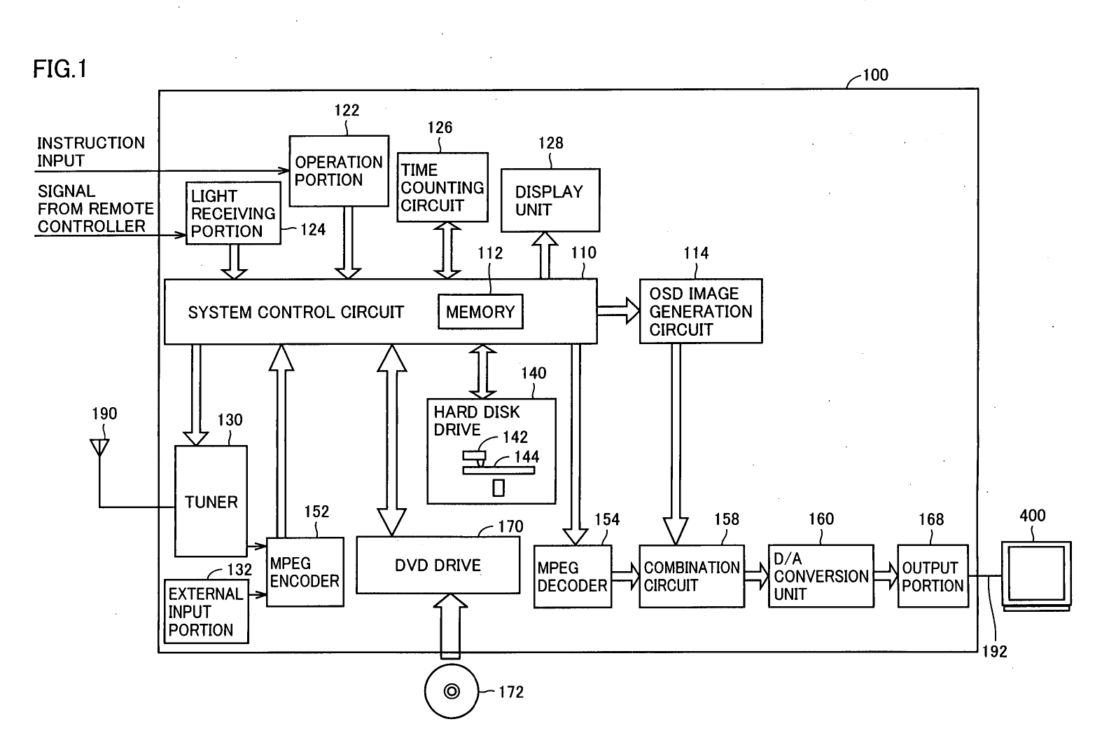

FIG. 1 is a block diagram showing a hardware configuration of a DVD recorder 100.

DVD recorder 100 includes a memory 112 for storing data and a program, a system control circuit 110 for performing processing predetermined based on stored data and an externally input instruction, an operation portion 122 for receiving an external input of an instruction from a user, a light-receiving portion 124 for receiving a signal from a remote controller and outputting a predetermined control signal to system control circuit 110, a time counting circuit 126 for counting time and outputting a signal to system control circuit 110, and a display unit 128 for displaying information indicating an operation state of DVD recorder 100.

Referring again to FIG. 1, DVD recorder 100 further includes an antenna 190, a tuner 130 for selecting a predetermined radio wave from received radio waves, an external input portion 132 for receiving an external input of video and audio signals, an MPEG (Moving Picture Experts Group) encoder 152 for compressing the input signals based on predetermined processing, a hard disk drive 140 for storing digital data based on an instruction from system control circuit 110, a DVD drive 170 for driving a DVD 172 so as to record or reproduce video and audio data, an MPEG decoder 154 for decoding the compressed video and audio signals, an OSD (On Screen Display) image generation circuit 114 for generating a signal for displaying the operation state or other information of DVD recorder 100 on a video display screen, a combination circuit 158 for combining a signal generated by OSD image generation circuit 114 with a signal output from MPEG decoder 154 and outputting the combined signal, a D/A (Digital to Analog) conversion unit 160 for converting an input digital signal to an analog signal and outputting the resultant signal, and an output portion 168 for outputting the video and audio signals, to which a transmission cable 192 can be connected. DVD recorder 100 is connected to a television set 400 via transmission cable 192.

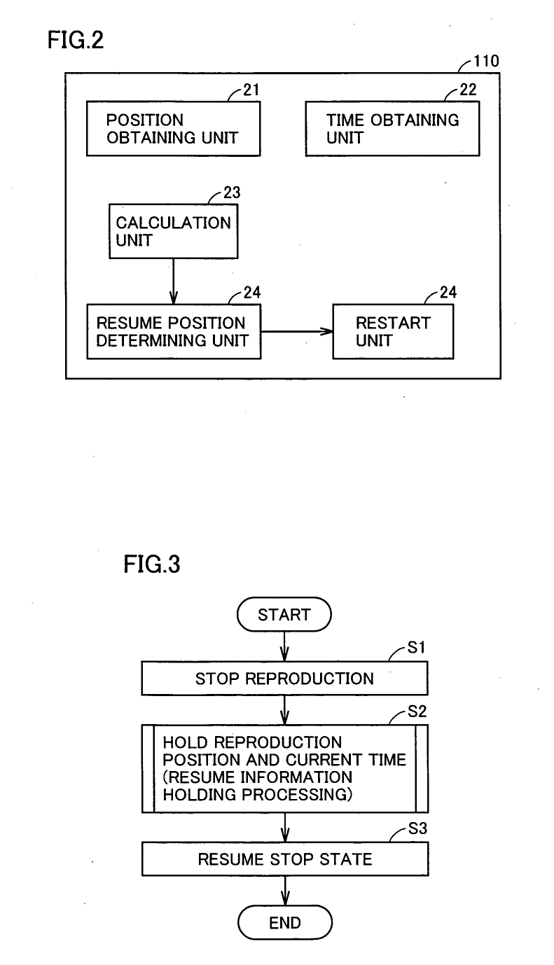

FIG. 2 is a functional block diagram of system control circuit 110 of the embodiment of the present invention. Referring to FIG. 2, system control circuit 110 includes a position obtaining unit 21 for obtaining a position at which reproduction was stopped (hereinafter, referred to as a “reproduction position”), a time obtaining unit 22 for obtaining the time at which the reproduction was stopped, a calculation unit 23 for calculating a time period elapsed from the stop of the reproduction when an input designating the resume reproduction is received, a resume position determining unit 24 for determining a resume position of the reproduction based on the calculated time period, and a restart unit 25 for restarting the reproduction at the determined resume position. The operation of each functional block may be implemented by software stored in memory 112, or at least one of the operations may be implemented by hardware.

Although DVD 172 is explained in the present embodiment, the recording medium is not restricted to such a removable medium, but it may be, e.g., a hard disk 144 initially built in.

Resume processing in the embodiment of the present invention will now be explained using the flowcharts shown in FIGS. 3-5.

Normally, the resume function refers to a function where when a user operates a remote controller or the like to stop reproduction, the reproduction is restarted from that position. The “resume processing” in the present embodiment refers to processing for restarting the intermitted reproduction, and the “resume reproduction” refers to a configuration where reproduction is restarted from the resume position determined based on the reproduction position described above.

FIG. 3 shows processing that is started when system control circuit 110 detects an input to instruct stop of reproduction of DVD 172 based on a signal input from operation portion 122 or light-receiving portion 124. Here, it is assumed that there is no user operation designating resume cancellation.

Referring to FIG. 3, system control circuit 110 firstly controls DVD drive 170 based on an instruction from the user to stop reading of video and audio data recorded on DVD 172 (step S1). That is, it stops outputting of video images to television set 400.

System control circuit 110 then stores resume information at the time when the reading of the video and audio data recorded on DVD 172 was stopped in step S1, i.e., the reproduction position and the current time, in memory 112 (step S2).

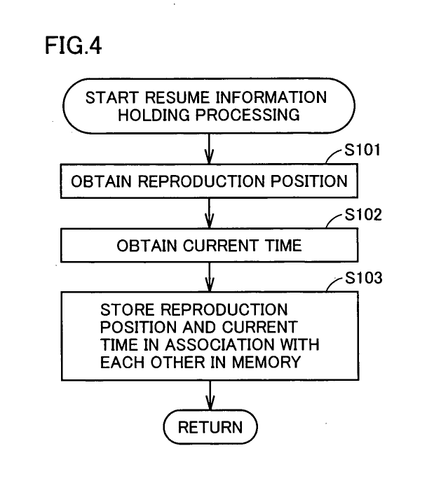

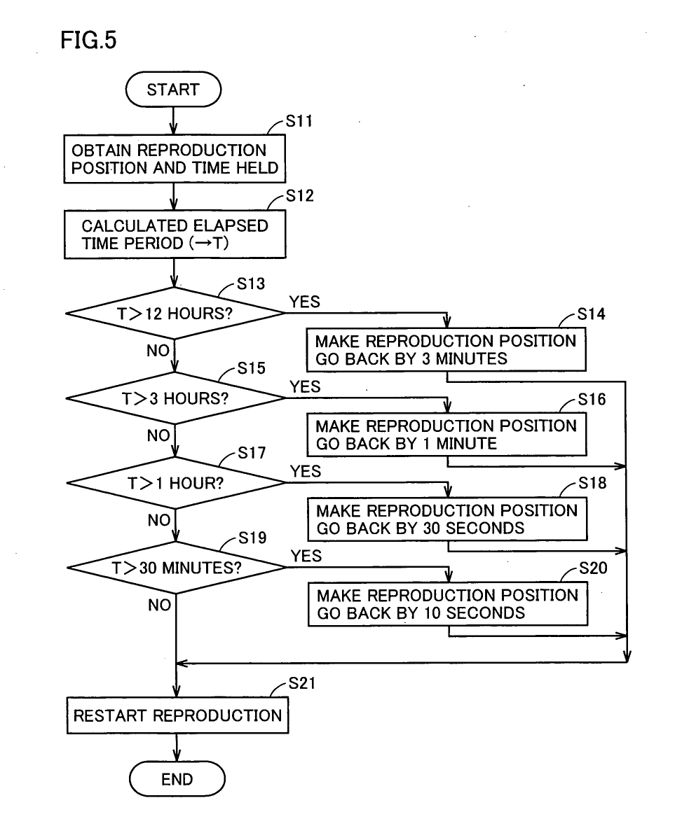

The resume information holding processing in the above-described step S2 in the present embodiment is now described in more detail using the flowchart of FIG. 4. Referring to FIG. 4, firstly, system control circuit 110 obtains the reproduction position of DVD 172 (step S101). Here, the reproduction position corresponds to the stop position. Specifically, the position on DVD 172 where the video and audio data were read at the last is obtained as the reproduction position, which may be, e.g., an address. Alternatively, address information may be obtained as the reproduction position, or a period of time elapsed from the time when reproduction was started to the time when the reproduction was stopped may be obtained.

Next, system control circuit 110 obtains the current time from time counting circuit 126 (step S102).

It stores the obtained reproduction position and the current time in association with each other in memory 112 (step S103).

Once the reproduction position and the current time are stored in step S2 as described above, DVD recorder 100 enters a resume stop state (step S3). The “resume stop state” refers to the state where the resume reproduction is possible.

As such, the reproduction position and the time when reproduction was stopped are stored as the resume information in memory 112. If DVD recorder 100 is capable of mounting a plurality of DVDs, their resume information is stored in memory 112. In this case, an ID (Identification) number or the like of each DVD 172 is stored together with the corresponding resume information in each storage area.

FIG. 5 shows processing that is started when system control circuit 110 detects an input instructing restart of the reproduction based on a signal input from operation portion 122 or light-receiving portion 124. Here, it is assumed that there is no user input instructing normal reproduction. The normal reproduction refers to reproduction where video and audio data recorded on DVD 172 is read from the beginning, without conducting the resume reproduction. Further, the processing shown in the flowchart of FIG. 5 is prestored as a program in memory 112. The program is read from memory 112 and executed by system control circuit 110 to implement the resume reproduction function.

Referring to FIG. 5, firstly, system control circuit 110 reads from memory 112 resume information corresponding to DVD 172 for which reproduction is to be restarted, based on a signal input from operation portion 122 or light-receiving portion 124. Specifically, the reproduction position and the stop time of reproduction, held in memory 112 in step S2 of FIG. 3, are obtained (step S11).

System control circuit 110 obtains the current time from time counting circuit 126, and calculates a period of time “T” elapsed from the stop time of reproduction (step S12).

Next, system control circuit 110 determines a resume position based on the elapsed time period “T” calculated in step S12 (steps S13-S20).

Firstly, system control circuit 110 determines whether the elapsed time period “T” calculated in step S12 exceeds, e.g., 12 hours (step S13). If it is determined that elapsed time period “T” exceeds 12 hours (YES in step S13), a position going back by 3 minutes, for example, from the reproduction position obtained in step S11 is decided as the resume position (step S14). System control circuit 110 then controls DVD drive 170 to read and reproduce the video and audio data recorded on the mounted DVD 172 from the resume position decided in step S14 (step S21). As such, video images are output to television set 400 from the point 3 minutes earlier than the time of stop of the reproduction.

If elapsed time period “T” is equal to or less than 12 hours (NO in step S13), system control circuit 110 determines whether elapsed time period “T” exceeds, e.g., 3 hours (step S15).

If it is determined that elapsed time period “T” exceeds 3 hours (YES in step S15), system control circuit 110 decides a position going back by 1 minute, for example, from the reproduction position obtained in step S11 as a resume position (step S16). System control circuit 110 then controls DVD drive 170 to read and reproduce video and audio data recorded on the mounted DVD 172 from the resume position decided in step S16 (step S21). As such, video images are output to television set 400 from the point 1 minute earlier than the time of stop of the reproduction.

If elapsed time period “T” is equal to or less than 3 hours (NO in step S15), system control circuit 110 determines whether elapsed time period “T” exceeds one hour, for example (step S17).

If it is determined that elapsed time period “T” exceeds one hour (YES in step S17), system control circuit 110 decides a position going back by 30 seconds, for example, from the reproduction position obtained in step S11 as a resume position (step S18). System control circuit 110 then controls DVD drive 170 to read and reproduce the video and audio data recorded on the mounted DVD 172 from the resume position decided in step S18 (step S21). As such, video images are output to television set 400 from the point 30 seconds earlier than the time of stop of the reproduction.

If elapsed time period “T” is equal to or less than one hour (NO in step S17), system control circuit 110 determines whether elapsed time period “T” exceeds 30 minutes, for example (step S19).

If it is determined that elapsed time period “T” exceeds 30 minutes (YES in step S19), system control circuit 110 decides a position going back by 10 seconds, for example, from the reproduction position obtained in step S11 as a resume position (step S20). System control circuit 110 then controls DVD drive 170 to read and reproduce the video and audio data recorded on the mounted DVD 172 from the resume position decided in step S20 (step S21). As such, video images are output to television set 400 from the point 10 seconds earlier than the time of stop of the reproduction.

If it is determined that elapsed time period “T” is equal to or less than 30 minutes (NO in step S19), system control circuit 110 controls DVD drive 170 to read and reproduce the video and audio data recorded on the mounted DVD 172 from the reproduction position obtained in step S11 (step S21). In this case, video images are output to television set 400 from the point at the time of stop of the reproduction.

It is often the case, when a user forgets the flow of the story after a while since the reproduction was intermitted, the user himself/herself operates to cause the reproduction to be restarted from an earlier point as appropriate.

In the above-described DVD recorder 100 according to the embodiment of the present invention, the resume position is automatically set to a position going back by a certain time period that is decided according to the length of the time period elapsed from the time when the reproduction was stopped. This reduces the burden of operation of the user, and also facilitates recalling of the flow of the story.

In the present embodiment, time counting circuit 126 is used to obtain the time when the reproduction was stopped and the time when the reproduction is to be restarted, to calculate elapsed time period “T”. The present invention however is not restricted thereto. For example, counting of the time may be started after the stop time of reproduction is set to zero. In this case, counting of the time is stopped upon reception of an input instructing restart of reproduction, and elapsed time period “T” is calculated.

Further, in the present embodiment, even if a power is turned off, the similar resume processing can be carried out. In this case, memory 112 is replaced with a non-volatile memory to hold the reproduction position and the stop time of reproduction (see step S2 of FIG. 3). With this configuration, the resume information is held even if the power is turned off, enabling the resume reproduction processing as shown in FIG. 5.

Still further, in the case where the recording medium is removable like DVD 172, the resume information may be stored in a non-volatile memory (not shown) in association with an ID number or the like of the recording medium. In doing so, even if the recording medium is once removed, it is possible to conduct the resume reproduction processing as shown in FIG. 5, since the resume information can be obtained by reading the ID.

Still further, it may be configured to allow the user to preset the time periods shown in steps S13-S20 of FIG. 5. Alternatively, the user may change the preset time periods. In these cases, a menu displayed when a user operates a remote controller or the like (not shown) includes a menu for setting a time period to be moved back upon the resume reproduction. Whit this configuration, the reproduction can be restarted automatically at a point going back by a desired time period from the point where the reproduction was stopped.

Modification

A modification of the above-described embodiment of the present invention will now be described. The configuration and function of the data reproduction apparatus according to the modification of the embodiment are similar to those of the embodiment described above. Thus, description is made using the reference characters shown in FIGS. 1 and 2.

In the above-described embodiment, the resume information (the reproduction position and the current time) when the reproduction was stopped is stored in memory 112 (see step S103 in FIG. 4). In the modification of the embodiment, the resume information at the time of stop of the reproduction is stored in the recording medium that stores the data to be reproduced. Storing the resume information in the recording medium enables the resume reproduction of the present invention to be carried out even if the removable recording medium is once removed.

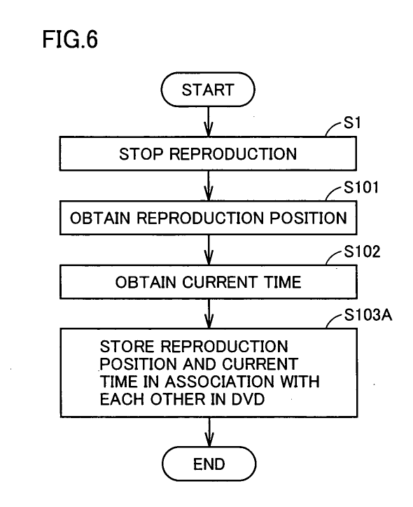

FIG. 6 shows processing in the modification of the embodiment that is started when system control circuit 110 detects an input instructing stop of reproduction of DVD 172 based on a signal input from operation portion 122 or light-receiving portion 124. The processing steps similar to those in the flowcharts of FIGS. 3 and 4 are denoted by the same step numbers, and description thereof will not be repeated here.

Referring to FIG. 6, system control circuit 110 firstly controls DVD drive 170 based on an instruction from a user to stop reading of video and audio data recorded on DVD 172 (step S1). System control circuit 110 then obtains a reproduction position of DVD 172 (step S101). Next, system control circuit 110 obtains the current time from time counting circuit 126 (step S102).

System control circuit 110 then stores the obtained resume information, i.e., the reproduction position and the current time, in association with each other in a certain area of DVD 172 (step S103A). The certain area of DVD 172 refers to, e.g., an empty recording area where video/audio data is to be recorded.

As such, the resume information is directly stored in DVD 172 as an object of reproduction. Accordingly, even if the user once removes DVD 172, the resume reproduction can be carried out when it is mounted again. It is possible, following step S1, to allow the user to decide whether to store the resume information or not. In this case, the processing in steps S101-S103A is carried out only when the user decides to store the resume information.

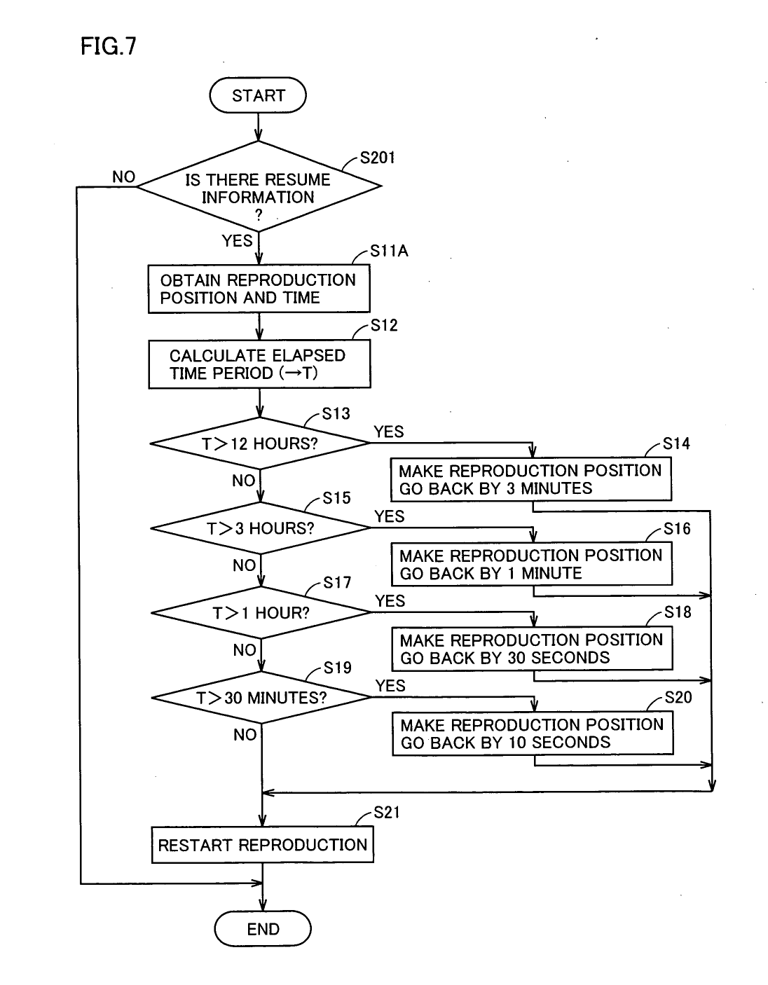

Resume reproduction processing in the modification of the embodiment will now be described with reference to FIG. 7. The processing steps similar to those in the flowchart of FIG. 5 are denoted by the same step numbers, and description thereof will not be repeated here.

The processing shown in FIG. 7 is started when system control circuit 110 detects an input instructing reproduction of DVD 172 based on a signal input via operation portion 122 or light-receiving portion 124.

Referring to FIG. 7, system control circuit 110 determines whether resume information is stored in DVD 172 (step S201). If the resume information is stored in DVD 172 (YES in step S201), the resume information, i.e., the reproduction position and the time, is read out (step S11A).

After step S11A, steps S12-S21 are carried out as in the above embodiment.

If it is determined in step S201 that the resume information is not stored in DVD 172 (NO in step S201), the process is terminated, without conducting a series of resume reproduction processing. That is, video and audio data recorded on DVD 172 is read and reproduced from the beginning.

In the modification of the embodiment as well, it is possible to allow the user to choose resume reproduction or normal reproduction.

Although the DVD recorder has been explained as one type of the data reproduction apparatus in the embodiment and its modification, the present invention is not restricted thereto. Further, the data to be reproduced may be video data alone or audio data alone, instead of the video and audio data described above.

Instead of DVD 172 described above, for example an optical medium recording a program may be read using a corresponding drive to update the program in memory 112.

In addition, the method of resume processing, performed by the data reproduction apparatus according to the present invention, may be provided as a program. Such a program may be recorded on an optical medium such as a CD-ROM (Compact Disc-ROM) or a computer-readable recording medium such as a memory card, so as to be provided as a program product. Moreover, the program may be downloaded through a network.

The provided program product is installed in a program storage unit such as memory 112 and executed. The program product includes a program itself and a recording medium on which the program is recorded.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data reproduction apparatus, comprising:
a reproduction unit for performing a reproduction operation of data recorded on a recording medium;
a position obtaining unit for obtaining a stop position of said reproduction operation on said recording medium when said reproduction operation by said reproduction unit is stopped;
a position storage unit for storing said stop position obtained by said position obtaining unit;
a calculation unit for calculating a first time period elapsed from the time of stop of said reproduction operation when an input designating resume reproduction for said reproduction operation by said reproduction unit is received; and
a resume position determining unit for determining a resume position of said reproduction operation with reference to said stop position stored in said position storage unit, based on said first time period calculated by said calculation unit.

2. The data reproduction apparatus according to claim 1, wherein said resume position determining unit determines a position going back by a second time period from said stop position stored in said position storage unit as said resume position, by selecting one of predetermined time periods as said second time period based on said first time period.

3. The data reproduction apparatus according to claim 2, further comprising a modification unit for modifying said predetermined time periods based on an instruction from a user.

4. The data reproduction apparatus according to claim 1, further comprising a time obtaining unit for obtaining a stop time at which said reproduction operation by said reproduction unit was stopped, wherein
said position storage unit stores said stop time obtained by said time obtaining unit and said stop position in association with each other.

5. The data reproduction apparatus according to claim 1, further comprising a restart unit for restarting the reproduction of said data recorded on said recording medium from said resume position determined by said resume position determining unit.

6. The data reproduction apparatus according to claim 1, wherein said position storage unit is included in said recording medium.

7. The data reproduction apparatus according to claim 1, wherein said position storage unit is capable of holding information in a non-volatile manner.

8. The data reproduction apparatus according to claim 1, wherein said recording medium is provided in advance in said data reproduction apparatus.

9. The data reproduction apparatus according to claim 1, wherein said recording medium is removable.

10. The data reproduction apparatus according to claim 9, wherein
said position storage unit is capable of holding information in a non-volatile manner, and
said position storage unit stores said stop position in association with identification information of said recording medium.

11. The data reproduction apparatus according to claim 10, wherein said position storage unit stores said stop position and a stop time at which said reproduction operation by said reproduction unit was stopped, in association with each other.

12. The data reproduction apparatus according to claim 1, wherein said position obtaining unit obtains said stop position based on a time period elapsed from the time when said reproduction operation of said data recorded on said recording medium was started to the time when said reproduction was stopped.

13. A program product recording a program for causing a computer to perform resume processing, said program comprising the steps of:
performing a reproduction operation of data recorded on a recording medium;
obtaining a stop position of said reproduction operation on said recording medium when said reproduction operation is stopped;
calculating a first time period elapsed from the time of stop of said reproduction when an input designating resume reproduction for said reproduction operation is received; and
determining a position going back by a second time period from said obtained stop position as a resume position of said reproduction operation, by selecting one of predetermined time periods as said second time period based on said calculated first time period.
